(19) United States
(12) Patent Application Publication
(10) Pub. No.: US 2025/0328288 A1
(43) Pub. Date: Oct. 23, 2025

(54) STORAGE SYSTEM AND COMMAND EXECUTION METHOD

(71) Applicant: Hitachi Vantara, Ltd., Yokohama-shi (JP)

(72) Inventor: Nobuya MORIMOTO, Tokyo (JP)

(21) Appl. No.: 18/828,034

(22) Filed: Sep. 9, 2024

(30) Foreign Application Priority Data
Apr. 18, 2024 (JP) 2024-067710

(51) Int. Cl. G06F 3/06

(52) U.S. Cl. CPC G06F 3/0659; G06F 3/0605; G06F 3/067

(57) ABSTRACT

A second operation unit includes a division processing unit configured to determine whether data in a specific format exceeds a predetermined threshold size, and divide the data in the specific format into a plurality of pieces of unit data in the specific format each having a predetermined size when a determination is made that the data in the specific format exceeds the predetermined threshold size. A controller includes a command processing unit configured to restore a command based on the plurality of pieces of unit data in the specific format.

### CROSS-REFERENCE TO RELATED APPLICATION

The present application claims priority from Japanese application JP2024-067710, filed on Apr. 18, 2024, the content of which is hereby incorporated by reference into this application.

### BACKGROUND OF THE INVENTION

### 1. Field of the Invention

The present invention is suitably applied to a storage system and a command execution method relating to a technique for improving operability when a command is input.

### 2. Description of Related Art

In an information processing system, in order to execute a command for performing a certain operation, for example, an operation unit (hereinafter, referred to as a “second operation unit”) using a character user interface (CUI) that is used to input the command in text is provided in addition to an operation unit (hereinafter, referred to as a “first operation unit”) using a so-called graphic user interface (GUI) for inputting the command by operating a display object displayed in a graphic using a browser. An information processing system is provided which simultaneously provides a first operation unit and a second operation unit, and interlocks these operation units to complement the input of the command or display a corresponding command execution result (for example, see PTL 1 and PTL 2).

### CITATION LIST

### Patent Literature

PTL 1: JP2007-114935A
PTL 2: JP2010-043924A

### SUMMARY OF THE INVENTION

However, in the techniques described in PTL 1 and PTL 2, since the first operation unit using the GUI and the second operation unit using the CUI are independent of each other, it is necessary to install and activate software providing the operation units in the computer, respectively, and operability is not good.

The invention has been made in view of the above points, and aims to provide a storage system and a command execution method capable of improving operability for inputting a command and reliably and accurately executing the input command.

In order to solve the above problem, the invention provides a storage system including: a drive device configured to store data; a controller configured to control the drive device; and a control device configured to issue, to the controller, a command for controlling the drive device. The control device includes a first operation unit receiving the command by a graphic user interface; and a second operation unit integrated using the graphic user interface and receiving the command from a text input. The second operation unit includes a conversion processing unit converting a character string of the input command into data in a specific numeral system to obtain data in a specific format, and a division processing unit determining whether the data in the specific format exceeds a predetermined threshold size, and dividing the data in the specific format into a plurality of pieces of unit data in the specific format each having a predetermined size when the division processing unit determines that the data in the specific format exceeds the predetermined threshold size. The controller includes a command processing unit restoring the command based on the plurality of pieces of unit data in the specific format.

The invention provides a command execution method using a storage system that includes a drive device configured to store data, a controller configured to control the drive device, and a control device configured to issue, to the controller, a command for controlling the drive device. The method includes: a command receiving step of a graphic user interface being capable of receiving the command using a first operation unit, and being capable of receiving the command using a second operation unit from a text data input while integrating the second operation unit with the first operation unit using the graphic user interface in the control device; a conversion step of a conversion processing unit converting a character string of the input command into data in a specific numeral system to obtain data in a specific format; a division step of a division processing unit determining whether the data in the specific format exceeds a predetermined threshold size, and dividing the data in the specific format into a plurality of pieces of unit data in the specific format each having a predetermined size when a determination is made that the data in the specific format exceeds the predetermined threshold size; and a restoration step of a command processing unit restoring the command based on the plurality of pieces of unit data in the specific format in the controller.

According to the invention, it is possible to improve operability for inputting a command and to reliably and accurately execute the input command.

### BRIEF DESCRIPTION OF THE DRAWINGS

FIG. 1 is a system configuration diagram showing a configuration example of a storage system according to the present embodiment.

FIG. 2 is a block diagram showing a configuration example of a command console shown in FIG. 1.

FIG. 3 is a diagram showing an example of processing contents of a conversion processing unit of the command console.

FIG. 4 is a block diagram showing a configuration example of a web adapter shown in FIG. 1.

FIG. 5 is a timing chart showing an example of a command execution method using the storage system according to the present embodiment.

### DESCRIPTION OF EMBODIMENTS

Hereinafter, an embodiment of the invention will be described in detail with reference to the drawings.

### 1. Configuration of Storage System

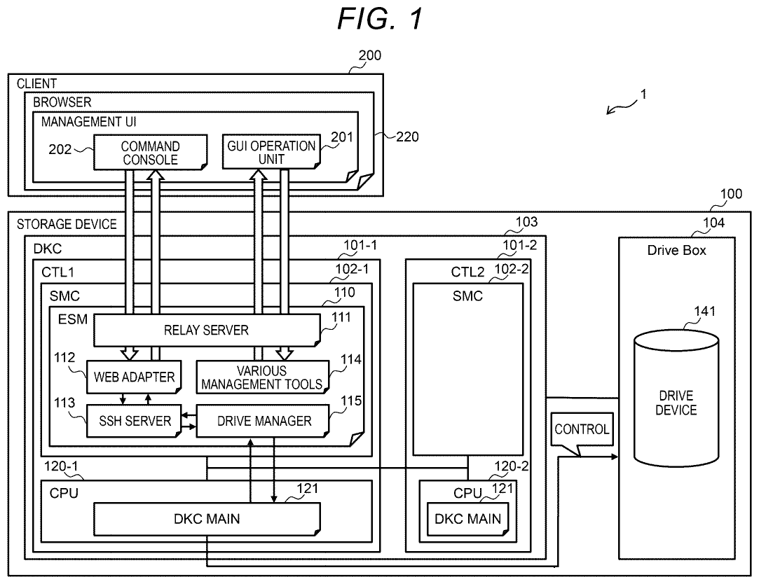

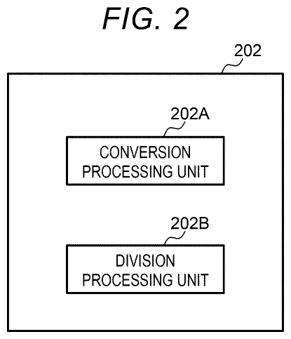

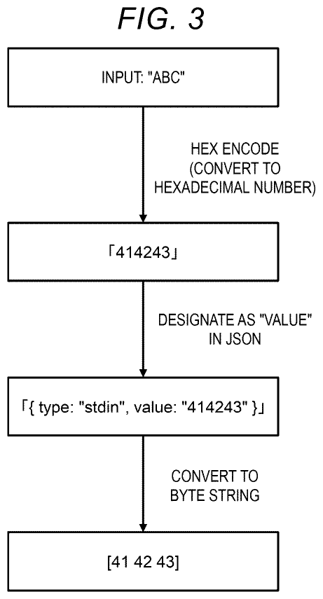

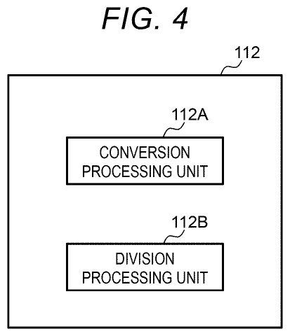

FIG. 1 is a system configuration diagram showing a configuration example of a storage system 1 according to the present embodiment. FIG. 2 is a block diagram showing a configuration example of a command console 202 shown in FIG. 1. FIG. 3 is a diagram showing an example of processing contents of a conversion processing unit 202A of the command console 202. FIG. 4 is a block diagram showing a configuration example of a web adapter 112 shown in FIG. 1. Each of arrows shown in the drawings is an example of a flow of a command or data, and the command and the data may be exchanged in a direction different from a direction of the arrow.

A storage system 1 includes a storage device 100 and a client computer 200. As shown in FIG. 1, the storage system 1 includes the storage device 100 and the client computer (hereinafter, referred to as a “client”) 200 that is an example of a control device. The storage device 100 includes a drive device 141 that stores data and a disk controller (hereinafter, referred to as a “controller”, and also referred to as a “DKC”) 103 that controls reading and writing of data from and to the drive device 141. The client computer 200 issues a command for controlling the storage device 100. The controller 103 is, for example, a device including a group of components having various functions such as a control device for the drive device 141, a processor, a cooling fan, and a power supply device. The client 200 and the storage device 100 are connected to a communication network, for example, the Internet.

The controller 103 is a device that controls and manages the storage device 100, and includes a first controller 101-1 (corresponding to a shown “CTL1”) and a second controller 101-2 (corresponding to a shown “CTL2”). When one of the e first controller 101-1 and the second controller 101-2 is blocked, the other controller executes a function of the one instead. Since the first controller 101-1 and the second controller 101-2 have similar configurations and functions, the first controller 101-1 will be described below. In a shown example, a detailed configuration of the second controller 101-2 is not shown.

The client 200 runs, for example, a browser using a graphic user interface (GUI). The client 200 is operable on a browser 220, and includes a GUI operation unit 201 and a command console 202. That is, the GUI operation unit 201 and the command console 202 are both activated on the browser 220 using the GUI. The client 200 loads a corresponding program by a built-in processor (not shown) to execute a function of the browser 220.

The GUI operation unit 201 is an example of a first operation unit, and receives a command by the GUI. The command console 202 is an example of a second operation unit, and for example, is integrated with the GUI operation unit 201 using the GUI as a management user interface, and receives a command from a text data input from an input device (not shown) such as a keyboard, a mouse, a card reader, and a touch panel. Details of the command console 202 will be described later.

The first controller 101-1 includes a storage management controller (SMC) 102-1. The SMC 102-1 is a processor that operates management software to be described later. The SMC 102-1 includes an embedded storage manager (ESM) 110 that is a management software main body. The ESM 110 includes a relay server 111, a web adapter 112, an SSH server 113, various management tools 114, and a drive manager 115. The SMC 102-1 executes a function of the management software by loading a corresponding program.

The relay server 111 is an example of a relay unit, and relays data between the command console 202 and the web adapter 112. That is, the relay server 111 relays data communication with the command console 202 of the browser 220 of the client 200 using, for example, WebSocket over SSL/TLS (WSS) as a protocol. The relay server 111 relays data with the web adapter 112 using, for example, WebSocket communication.

In the present embodiment, the command console 202 and the storage device 100 perform data communication using, for example, the WSS as a protocol.

The web adapter 112 exchanges data and a command with the SSH server 113 by, for example, a secure shell (SSH) connection. The web adapter 112 includes a conversion processing unit 112A and a division processing unit 112B as shown in FIG. 4. Details of the conversion processing unit 112A and the division processing unit 112B will be described later.

The relay server 111 relays data communication between the GUI operation unit 201 of the client 200 and the various management tools 114 using, for example, hypertext transfer protocol (HTTP)/hypertext transfer protocol secure (HTTPS) as a protocol.

As shown in FIG. 2, the command console 202 described above includes a conversion processing unit 202A and a division processing unit 202B. When a command is input from the client 200 to the storage device 100, for example, as shown in FIG. 3, the conversion processing unit 202A converts (HEX encodes) a character string (for example, “ABC”) of the input command into hexadecimal data that is an example of data in a specific numeral system, and sets the hexadecimal data (for example, “414243”) as a value in a JavaScript (registered trademark) object notation (JSON) format that is an example of a specific format. Command data (message) in the JSON format at a time of input can be, for example, {type: “stdin”, value, “414243”}. The JSON format is an example. The command console 202 recognizes the command data as unicode transformation format (UTF)-8 and performs data communication with the storage device 100. However, the character string of the input command is sent as the hexadecimal data by the command data in the JSON format described above.

The division processing unit 202B determines whether the command data in the JSON format exceeds a predetermined threshold size (for example, 8192 bytes). When the division processing unit 202B determines that the command data in the JSON format exceeds the predetermined threshold size (for example, 8192 bytes), the division processing unit 202B divides the command data in the JSON format into pieces of unit command data in the JSON format each having a predetermined size (for example, 8192 bytes) and transmits the unit command data in the JSON format to the web adapter 112 via the relay server 111. That is, the data obtained by performing hexadecimal conversion on the character string of the input command is divided such that a plurality of pieces of command data in the JSON format to be generated are each within the predetermined size, and unit command data in the JSON format is generated for each of the pieces of divided data.

When the division processing unit 202B determines that the command data in the JSON format does not exceed the predetermined threshold size, the division processing unit 202B transmits the command data in the JSON format as it is to the web adapter 112 via the relay server 111 without dividing the command data in the JSON format.

When result data is output from the storage device 100 to the client 200, with respect to command data in the JSON format including hexadecimal converted command execution result data (hereinafter, referred to as “result data in the JSON format”) designated as a value in the JSON format, the conversion processing unit 202A converts the command execution result data into a character code in UTF-16. The command console 202 displays a result based on the result data in the JSON format on a display device (not shown) using, for example, the browser 220. The division processing unit 202B restores the result data in the JSON format based on a plurality of pieces of the command execution result data in the JSON format or receives the result data in the JSON format as it is.

The web adapter 112 is an example of a command processing unit, and includes the conversion processing unit 112A and the division processing unit 112B as shown in FIG. 4.

When a command is input from the client 200 to the storage device 100, the conversion processing unit 112A converts result data in the JSON format included in command data in the JSON format received from the relay server 11 into byte string data, and transmits the byte string data to the SSH server 113. For example, as shown in FIG. 3, the conversion processing unit 112A converts the hexadecimal data (for example, “414243”) converted by the conversion processing unit 202A of the command console 202 into data in a byte string format (for example, “41 42 43”) and outputs the data to the SSH server 113. The division processing unit 202B restores result data in the JSON format based on a plurality of pieces of unit command data in the JSON format or receives command data in the JSON format as it is.

When result data is output from the storage device 100 to the client 200, the conversion processing unit 112A generates data by decoding, in a specific numeral system (for example, hexadecimal number), a character string of the command result data received from the SSH server 113, and generates command data in the JSON format which includes the decoded data as the result data in the JSON format.

The division processing unit 112B determines whether the command data in the JSON format exceeds a predetermined threshold size (for example, 8192 bytes). When the division processing unit 112B determines that the command data in the JSON format exceeds the predetermined threshold size, the division processing unit 112B divides the command data in the JSON format into a plurality of pieces of unit result data in the JSON format each having a predetermined size (for example, 8192 bytes), and transmits the unit result data in the JSON format to the relay server 111. Similarly to the division processing unit 202B of the command console 202, in this case as well, data obtained by performing hexadecimal conversion on the character string of the input command is divided such that a plurality of pieces of command data in the JSON format to be generated are each within the predetermined size, and unit command data in the JSON format is generated for each of the pieces of divided data.

When the division processing unit 112B determines that the command data in the JSON format does not exceed the predetermined threshold size, the division processing unit 112B transmits the result data in the JSON format as it is to the command console 202 via the relay server 111 without dividing the result data in the JSON format.

The secure shell (SSH) server 113 shown in FIG. 1 is an example of a drive operation unit, and causes the drive manager 115, which is an example of a drive control unit, to execute an operation on the drive device 141 based on a restored command. The drive manager 115 has a function of executing, by a command, a function executable in the storage device 100.

The drive device 141 is stored in a drive box 104 and is, for example, a solid state drive (SSD) or a hard disk drive (HDD). The drive manager 115 controls a disk controller main (corresponding to a shown “DKCMAIN”) 121 to execute an operation on the drive device 141. The disk controller main 121 is a micro program that runs on the controller 103 (corresponding to the shown “DKC”) that is a backbone of the storage device 100. The first controller 101-1 includes a CPU 120-1 which is a processor for operating and setting the drive device 141. The CPU 120-1 executes a function of the disk controller main 121 by loading a micro program.

### 2. Command Execution Method Using Storage System

The storage system 1 according to the present embodiment has the above configurations, and an example of a command execution method using the storage system 1 will be described below.

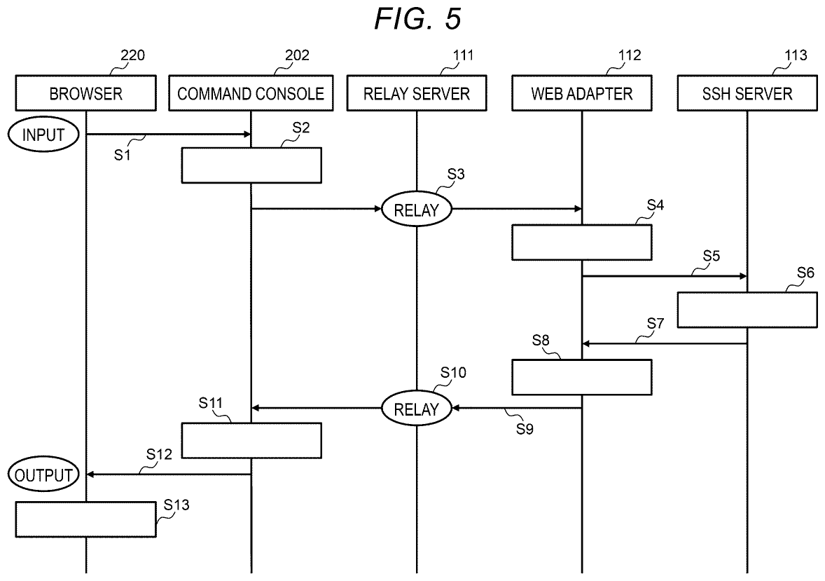

FIG. 5 is a timing chart showing the example of the command execution method using the storage system 1 according to the present embodiment. The command execution method mainly includes two types of command execution methods, that is, one at a time of input and one at a time of output. In the following description, “at a time of input” indicates a case in which a command is input from the client 200 to the storage device 100, and “at a time of output” indicates a case in which result data is output from the storage device 100 to the client 200.

### 2-1. At Time of Input

First, an outline of the command execution method at the time of input will be described.

In the client 200, first, the GUI operation unit 201 is capable of receiving a command, for example, by the GUI of the browser 220. Further, in the client 200, the command console 202 is capable of receiving a command from a text data input using the GUI of the browser 220.

The GUI operation unit 201 and the command console 202 are integrated in the browser 220 using the GUI described above. Therefore, for example, a command input for performing a predetermined operation on the drive device 141 can be input not only by the GUI using the GUI operation unit 201, but also by text using the command console 202. In this way, command input interfaces are integrated, and operability is good for a user who inputs the command.

At step S1, a command for operating data of the drive device 141 is input to the command console 202. A character code of a character string of the command is the UTF-16.

At step S2, the conversion processing unit 202A in the command console 202 converts the character string (for example, the UTF-16) of the input command into, for example, hexadecimal data, and sets the hexadecimal data as, for example, a value in the JSON format (referred to as “command data in the JSON format”).

At step S2, the division processing unit 202B in the command console 202 determines whether the command data in the JSON format exceeds a predetermined threshold size (for example, 8192 bytes). When the division processing unit 202B determines that the command data in the JSON format exceeds the predetermined threshold size, the division processing unit 202B divides the command data in the JSON format into pieces of unit command data in the JSON format each having a predetermined size (for example, 8192 bytes).

At step S2, when the division processing unit 202B in the command console 202 determines that the command data in the JSON format does not exceed the predetermined threshold size, the division processing unit 202B does not divide the command data in the JSON format.

The command console 202 transmits the command data in the JSON format, which has been divided or not divided as described above, to the relay server 111.

At step S3, the relay server 111 relays, to the web adapter 112, the command data in the JSON format received from the command console 202.

At step S4, the division processing unit 112B in the web adapter 112 receives a plurality of pieces of the divided unit command data in the JSON format (or the command data in the JSON format that is not divided), restores the command data in the JSON format based on the plurality of pieces of unit command data in the JSON format, and acquires the character string of the command based on the command data in the JSON format.

At step S5, in the first controller 101-1, the SSH server 113, which is the example of the drive operation unit, causes the drive manager 115, which is the example of a drive control unit, to execute an operation on the drive device 141 based on the restored command.

At step S6, the SSH server 113 receives, via the drive manager 115, result data output in response to the operation that is executed on the drive device 141 by the drive manager 115 based on the restored command.

### 2-2. At Time of Output

At step S7, the SSH server 113 transmits, to the web adapter 112, the result data representing a result of the operation executed by the drive manager 115.

At step S8, the conversion processing unit 112A in the web adapter 112 converts data obtained by decoding, in the hexadecimal number, the result data received from the SSH server 113 into result data (hereinafter, referred to as “result data in the JSON format”) designated as a value in the JSON format. Further, at step S8, when the division processing unit 112B in the web adapter 112 determines that the result data in the JSON format exceeds a predetermined threshold size (for example, 8192 bytes), the division processing unit 112B divides the result data in the JSON format into pieces of unit result data in the JSON format each having a predetermined size (for example, 8192 bytes).

Meanwhile, at step S8, when the division processing unit 112B in the web adapter 112 determines that the result data in the JSON format does not exceed the predetermined threshold size, the division processing unit 112B does not divide the result data in the JSON format into the pieces of unit result data in the JSON format having a predetermined size, and leaves the result data in the JSON format with the original size.

At step S9, the web adapter 112 transmits the result data in the JSON format divided as described above or left as it is to the relay server 111. At step S10, the relay server 111 relays, to the command console 202, the result data in the JSON format received from the web adapter 112.

At step S11, the command console 202 converts the character string designated as the value of the result data in the JSON format received from the relay server 111 from UTF-8 to the UTF-16, and passes the converted character string to the browser 220.

At step S13, the browser displays the result of the operation performed on the drive device 141 by the drive manager 115 based on the converted character string.

The storage 1 according system to the present embodiment includes the drive device 141 that stores data, the first controller 101-1 that controls the drive device 141, and the client 200 as a control device that issues a command for controlling the drive device 141. The client 200 includes the GUI operation unit 201 that receives a command by the graphic user interface, and a command console 202 that is integrated using the graphic user interface and receives a command from a text data input. The command console 202 includes the conversion processing unit 202A that converts a character string of an input command into hexadecimal data and obtains data in the JSON format, and a division processing unit 202B that determines whether the data in the JSON format exceeds a predetermined threshold size (for example, 8192 bytes) and divides the data in the JSON format into a plurality of pieces of unit data in the specific format each having a predetermined size (for example, 8192 bytes) when the division processing unit determines that the data in the JSON format exceeds the predetermined threshold size. The first controller 101-1 includes the web adapter 112 that restores the command based on the plurality of pieces of unit data in the JSON format.

In this way, the operability for inputting a command can be improved by integrating the command console 202 with the GUI operation unit 201, and a command input from the command console 202 can be reliably and accurately executed without being garbled midway through a command path even when the command is long.

In the present embodiment, the division processing unit 202B transmits the data in the JSON format to the command console 202 as it is when the division processing unit 202B determines that the data in the JSON format does not exceed the predetermined threshold size (for example, 8192 bytes). In this way, since the processing is not executed for the command data in the JSON format having a size with which the command data does not need to be divided, it is possible to efficiently operate at a high speed as a whole by allocating resources to other processing.

In the present embodiment, the GUI operation unit 201 and the command console 202 are both activated on the browser 220 using the graphic user interface. In this way, environment setting becomes easy, and even though the command console 202 is integrated with the GUI operation unit 201 on the browser 220, the command input from the command console 202 can be reliably and accurately executed without being garbled even when the command is long.

The storage system 1 according to the present embodiment includes the drive device 141 that transmits, to the SSH server 113 in the first controller 101-1, result data representing an execution result of a command executed by the first controller 101-1. The web adapter 112 converts the result data received from the SSH server 113 into result data in the JSON format, and divides the result data in the JSON format into pieces of unit result data in the JSON format each having a predetermined size (for example, 8192 bytes) when the web adapter 112 determines that the result data in the JSON format exceeds a predetermined threshold size. The division processing unit 202B in the command console 202 restores the result data in the JSON format based on a plurality of pieces of the unit result data in the JSON format. In this way, even when the result data obtained by executing the command is long, the result data is not garbled midway through the command path, and the command can be reliably and accurately executed.

In the present embodiment, the command console 202 displays the result based on the result data in the JSON format on the display device. In this way, since the data is not garbled midway through the command path as described above, the result based on the result data can be reliably and accurately displayed on the display device.

In the present embodiment, the web adapter 112 transmits the result data in the JSON format to the command console 202 as it is when the web adapter 112 determines that the result data in the JSON format does not exceed the predetermined threshold size (for example, 8192 bytes). In this way, when the result data in the JSON format does not exceed the predetermined threshold size, it is possible to more quickly display the result based on the result data on the display device by omitting some processing.

In the present embodiment, the first controller 101-1 includes the relay server 111 that relays data between the command console 202 and the web adapter 112. In this way, a load on a surrounding processing unit required to relay the command or the result data can be reduced due to presence of the relay server 111, and the surrounding processing unit can operate at a high speed accordingly.

In the present embodiment, the command console 202 operates as a part of the graphic user interface of the browser 220. In this way, the command console 202 is integrated in the browser 220, and thus the operability can be improved.

In the present embodiment, the command console 202 and the storage device 100 perform data communication using, for example, the WebSocket over SSL/TLS (WSS) as a protocol. The storage device 100 and the drive device 141 perform data communication using the solid state drive (SSD) transmission protocol.

The invention is not limited to the above-described embodiment, and includes various modifications and equivalent configurations within the scope of the appended claims. For example, the above-described embodiment is described in detail for easy understanding of the invention, and the invention is not necessarily limited to those including all the configurations described above. At least one of the elements described as being connected in parallel in the present embodiment may be connected in series to another element.

### INDUSTRIAL APPLICABILITY

The invention can be applied to a storage system related to a technique for improving operability, for example, at a time of inputting a command.

What is claimed is:

1. A storage system comprising:
a drive device configured to store data;
a controller configured to control the drive device; and
a control device configured to issue, to the controller, a command for controlling the drive device, wherein
the control device includes
a first operation unit receiving the command by a graphic user interface, and
a second operation unit integrated using the graphic user interface and receiving the command from a text data input,
the second operation unit includes
a conversion processing unit converting a character string of the input command into data in a specific numeral system to obtain data in a specific format, and
a division processing unit determining whether the data in the specific format exceeds a predetermined threshold size, and dividing the data in the specific format into a plurality of pieces of unit data in the specific format each having a predetermined size when the division processing unit determines that the data in the specific format exceeds the predetermined threshold size, and
the controller includes a command processing unit restoring the command based on the plurality of pieces of unit data in the specific format.

2. The storage system according to claim 1, wherein
the division processing unit transmits the data in the specific format as it is without dividing the data in the specific format when a determination is made that the data in the specific format does not exceed the predetermined threshold size.

3. The storage system according to claim 1, wherein
the first operation unit and the second operation unit are activated on a browser using the graphic user interface.

4. The storage system according to claim 1, wherein
the controller includes a drive operation unit configured to transmit result data representing an execution result of a command executed by the controller,
the command processing unit converts the result data into result data in the specific format, and divides the result data in the specific format into pieces of unit result data in the specific format each having a predetermined size when the command processing unit determines that the result data in the specific format exceeds the predetermined threshold size, and
in a command console, the division processing unit restores the result data in the specific format based on a plurality of pieces of the unit result data in the specific format.

5. The storage system according to claim 4, wherein
the second operation unit displays a result based on the result data in the specific format on a display device.

6. The storage system according to claim 4, wherein
the command processing unit transmits the result data in the specific format as it is when a determination is made that the result data in the specific format does not exceed the predetermined threshold size.

7. The storage system according to claim 1, wherein
the controller includes a relay unit configured to relay data between the second operation unit and the command processing unit.

8. The storage system according to claim 1, wherein
the second operation unit operates as a part of the graphic user interface of the browser.

9. The storage system according to claim 1, wherein
the second operation unit and a storage device perform data communication using WebSocket over SSL/TLS (WSS) as a protocol, and
the storage device and the drive device perform data communication using a solid state drive (SSD) transmission protocol.

10. A command execution method using a storage system including a drive device configured to store data, a controller configured to control the drive device, and a control device configured to issue, to the controller, a command for controlling the drive device, the method comprising:
a command receiving step of a graphic user interface being capable of receiving the command using a first operation unit, and being capable of receiving the command using a second operation unit from a text data input while integrating the second operation unit with the first operation unit using the graphic user interface in the control device;
a conversion step of a conversion processing unit converting a character string of the input command into data in a specific numeral system and obtaining data in a specific format;
a division step of a division processing unit determining whether the data in the specific format exceeds a predetermined threshold size, and dividing the data in the specific format into a plurality of pieces of unit data in the specific format each having a predetermined size when the division processing unit determines that the data in the specific format exceeds the predetermined threshold size; and
a restoration step of a command processing unit restoring the command based on the plurality of pieces of unit data in the specific format in the controller.
